(19) United States
(12) Patent Application Publication
(10) Pub. No.: US 2012/0190123 A1
(43) Pub. Date: Jul. 26, 2012

(54) STRUCTURAL ANALYSIS DEVICE AND STRUCTURAL ANALYSIS METHOD

(75) Inventors: Yasuchika Hasegawa, Ikoma-shi (JP); Tsuyoshi Kawai, Ikoma-shi (JP); Junpei Yuasa, Ikoma-shi (JP); Mikio Kataoka, Ikoma-shi (JP); Kohei Yamada, Nara-shi (JP)

(73) Assignee: National University Corporation Nara Institute of Science and Technology, Ikoma-shi, Nara (JP)

(21) Appl. No.: 12/737,990

(22) PCT Filed: Sep. 10, 2009
(86) PCT No.: PCT/JP2009/004467

§ 371 Date: May 19, 2011

(30) Foreign Application Priority Data
Sep. 10, 2008 (JP) 2008-232489

(51) Int. Cl. G01N 21/00

(52) U.S. Cl. 436/164; 422/82.05

(57) ABSTRACT

A molecular structure analysis device of at least one embodiment of the present invention includes: a light source for illuminating, with exciting light, a measurement sample including a molecule to be structurally analyzed to which molecule a rare earth complex is bonded; a measurement section for receiving light emitted from the measurement sample and for measuring intensities of spectra of the light; a calculation section for performing normalization in which intensities of spectra including a line spectrum due to electric dipole transition among the measured intensities of the spectra of the light are normalized by an intensity at one wavelength in a line spectrum due to magnetic dipole transition; and an output section for outputting the spectra whose intensities have been normalized. This makes it possible to attain a device and a method capable of analyzing minute change in a dynamic structure of the molecule.

### TECHNICAL FIELD

The present invention relates to: a molecular structure analysis method; and a molecular structure analysis device applicable to the molecular structure analysis method.

### BACKGROUND ART

Conventionally, there has been known a method for immobilizing a fluorescent probe to a biomolecule such as a protein in order to observe and analyze a change in a biomolecular higher-order structure.

There have been many reports on a fluorescent probe made from a rare earth complex. The reason for employing such a fluorescent probe is that (i) molecular weight of the fluorescent probe is relatively small, therefore the fluorescent probe is unlikely to be an inhibitor against a change in the biomolecular structure, (ii) the fluorescent probe has great emission intensity, therefore fluorescence observation of the biomolecule is easy to carry out, (iii) the fluorescent probe has a long fluorescent lifetime (several millimeter seconds), and it can eliminate a noise from the fluorescent biomolecule by delaying measurement for a prolonged time, and the like (see, for example, Non-Patent Literatures 1 and 2).

### CITATION LIST

### Non-Patent Literature

Non-Patent Literature 1

Jingli Yuan, Kazuko Matsumoto, Hiroko Kimura, Anal. Chem. 1998, 70, 596-601

Non-Patent Literature 2

Junhua Yu, David Parker, Robert Pal, Robert A. Poole, and Martin J. Cann, J. AM. CHEM. SOC. 2006, 128, 2294-2299

### SUMMARY OF INVENTION

### Technical Problem

However, it is difficult to analyze minute change in a biomolecular structure by means of the above-described method though the above-described method can provide positional information on the biomolecule.

The present invention is made in view of the above problem, and an object of the present invention is to attain a structural analysis device and a structural analysis method capable of analyzing minute change in a molecular structure.

### Solution to Problem

Inventors of the present invention studied diligently in order to attain the object. Specifically, the inventors measured, under various measurement conditions, emission spectra of a biomolecule to which a fluorescent probe has been immobilized in order to analyze a change in a biomolecular structure.

However, the inventors found that the emission spectra measurement by means of the above-described method under various measurement conditions such as a measurement temperature showed such a great change in a baseline and intensity of the measured emission spectra that it was impossible to determine whether or not such a change was attributed to the change in the biomolecular structure. This made it difficult to analyze the change in the biomolecular structure from the change in the emission spectra.

The inventors of the present invention further studied to find that it was possible to eliminate the influence other than the structural change of the molecule to which a rare earth complex was bonded, the elimination being attained by performing such a normalization that intensities of line spectrums due to electric dipole transition among the emission spectra are normalized by an intensity at one wavelength in a line spectrum due to magnetic dipole transition and that it was possible to analyze the minute change in the molecular structure from such spectra whose intensities had been normalized. The present invention was accomplished based on these findings.

A structural analysis device of the present invention, in order to attain the object, includes: a light source for illuminating, with exciting light, a measurement sample including a molecule to be structurally analyzed to which molecule a rare earth complex is bonded; a measurement section for receiving light emitted from the measurement sample and for measuring intensities of spectra of the light; a calculation section for performing normalization in which intensities of spectra including a line spectrum due to electric dipole transition among the measured intensities of the spectra of the light are normalized by an intensity at one wavelength in a line spectrum due to magnetic dipole transition; and an output section for outputting the spectra whose intensities have been normalized.

According to the above arrangement, it is possible to obtain emission spectra of the emitted light in which emission spectra the intensities of the spectra including the line spectrum due to the electric dipole transition are normalized by the intensity at the one wavelength in the line spectrum due to the magnetic dipole transition.

The line spectrum due to the magnetic dipole transition has emission intensity specific to a rare earth element of the rare earth complex. The line spectrum due to the electric dipole transition has emission intensity which changes depending on the types of a ligand in the surrounding of the rare earth element and which differs depending on the types of the rare earth complex.

That is, the line spectrum due to the magnetic dipole transition has the emission intensity that is not affected by structural change of a molecule to which a rare earth complex is bonded. Meanwhile, the line spectrum due to the electric dipole transition has the emission intensity that changes due to the structural change of the molecule to which the rare earth complex is bonded.

As described above, in the emission spectra, the intensities of the line spectrums due to the electric dipole transition are normalized by the intensity at the one wavelength in the line spectrum due to the magnetic dipole transition. Therefore, even in a case where the baseline and the intensity of the measured emission spectra greatly change due to change in the measurement condition such as the measurement temperature, it is possible to eliminate from the emission spectra the other influences than the structural change of the molecule to which the rare earth complex is bonded. By this, the structural change of the molecule to which the rare earth complex is bonded can be analyzed in further detail by analyzing the spectra whose intensities have been normalized.

Further, the emission spectra are measured in a shorter period of time than measurement of a CD spectrum conventionally employed for analysis of the structural change of the molecule.

According to the above arrangement, it is therefore possible to provide a device capable of measuring a spectrum in a short period of time and analyzing minute change in a molecular structure.

A structural analysis device of the present invention, in order to attain the object, includes: a light source for illuminating, with exciting light, a measurement sample including a molecule to be structurally analyzed to which molecule a rare earth complex is bonded; a measurement section for receiving light emitted from the measurement sample plural times and for measuring intensities of spectra of the light each time the light is received; a calculation section for performing normalization in which intensities of spectra including a line spectrum due to electric dipole transition among the measured intensities of the spectra of the light are normalized by an intensity at one wavelength in a line spectrum due to magnetic dipole transition; and an output section for outputting the spectra whose intensities have been normalized.

According to the above arrangement, it is possible to obtain a plurality of emission spectra groups of emitted light in which emission spectra the intensities of the spectra including the line spectrum due to the electric dipole transition are normalized by the intensity at the one wavelength in the line spectrum due to the magnetic dipole transition.

The line spectrum due to the magnetic dipole transition has the emission intensity that is not affected by the structural change of the molecule to which the rare earth complex is bonded. Meanwhile, the line spectrum due to the electric dipole transition has the emission intensity that changes due to the structural change of the molecule to which the rare earth complex is bonded.

As described above, in the emission spectra, the intensities of the line spectrums due to the electric dipole transition are normalized by the intensity at the one wavelength in the line spectrum due to the magnetic dipole transition. Therefore, even in the case where the baseline and the intensity of the measured emission spectra greatly change due to the change in the measurement condition such as the measurement temperature, it is possible to eliminate, from the emission spectra, the influence other than the structural change of the molecule to which the rare earth complex is bonded. On this account, the structural change of the molecule to which the rare earth complex is bonded can be analyzed in further detail by analyzing the spectra whose intensities have been normalized.

Further, the emission spectra are measured in a shorter period of time than the measurement of the CD spectrum conventionally employed for the analysis of the change in the molecular structure. It is therefore possible to analyze in further detail the change in the molecular structure over time.

According to the above arrangement, it is therefore possible to provide the device capable of measuring the spectrum in a short period of time and analyzing the minute change in the molecular structure.

It is preferable to arrange the structural analysis device of the present invention such that the molecule to be structurally analyzed is bonded with plural types of rare earth complexes, the calculation section performs normalization in which intensities of spectra including the line spectrums due to electric dipole transition from individual types of the rare earth complexes among the measured intensities of the spectra of the light are normalized by intensities at one wavelength in the respective line spectrums due to magnetic dipole transition from the individual types of the rare earth complexes.

According to the calculation section of the above arrangement, it is possible to obtain a plurality of spectra groups in which emission intensities of the spectra including the line spectrums due to the electric dipole transition from the individual types of the rare earth complexes are normalized by the intensities at the one wavelength in the respective line spectrums due to the magnetic dipole transition from the individual types of the rare earth complexes.

This makes it further possible to simultaneously analyze minute changes in the molecular structure which minute changes occur in different sites of the molecule.

It is preferable to arrange the structural analysis device of the present invention such that the measurement section measures, as the intensities of the spectra of the light, g values of circularly polarized light of the light emitted from the measurement sample.

According to the above arrangement, it is further possible to analyze in further detail the minute change in the molecular structure by measuring the g values of the circularly polarized light of the light emitted from the rare earth complex that is bonded to the molecule.

It is preferable to arrange the structural analysis device of the present invention such that the one wavelength at which the intensity of the line spectrum due to the magnetic dipole transition is attained is a maximum absorbance wavelength of the line spectrum due to the magnetic dipole transition.

According to the above arrangement, it is possible to analyze in further detail the minute change in the molecular structure.

It is preferable to arrange the structural analysis device of the present invention such that the molecule to be structurally analyzed is a protein.

It is preferable that the structural analysis device of the present invention further includes a structural analysis section, the calculation section outputs to the structural analysis section the spectra whose intensities have been normalized, the structural analysis section structurally analyzes the molecule from the spectra whose intensities have been normalized.

A structural analysis method of the present invention, in order to attain the object, includes: an illumination step for illuminating, with exciting light, a measurement sample including a molecule to be structurally analyzed to which molecule a rare earth complex is bonded; a measurement step for receiving light emitted from the measurement sample and measuring intensities of spectra of the light; a calculation step for performing normalization in which intensities of spectra including a line spectrum due to electric dipole transition among the measured intensities of the spectra of the light are normalized by an intensity at one wavelength in a line spectrum due to magnetic dipole transition; and a structural analysis step for analyzing a structure of the molecule from the spectra whose intensities have been normalized.

According to the calculation step of the above method, it is possible to obtain emission spectra of emitted light in which emission spectra the intensities of the spectra including the line spectrum due to the electric dipole transition are normalized by the intensity at the one wavelength in the line spectrum due to the magnetic dipole transition.

The line spectrum due to the magnetic dipole transition has emission intensity specific to a rare earth element of the rare earth complex. The line spectrum due to the electric dipole transition has emission intensity which changes depending on the types of a ligand in the surrounding of the rare earth element and which differs depending on the types of the rare earth complex.

That is, it is considered that the line spectrum due to the magnetic dipole transition has the emission intensity that is not affected by structural change of a molecule to which a rare earth complex is bonded, while the line spectrum due to the electric dipole transition has the emission intensity that changes due to the structural change of the molecule to which the rare earth complex is bonded.

As described above, in the emission spectra, the intensities of the line spectrums due to the electric dipole transition are normalized by the intensity at the one wavelength in the line spectrum due to the magnetic dipole transition. Therefore, even in a case where the baseline and the intensity of the measured emission spectra greatly change due to the change in the measurement condition such as the measurement temperature, it is possible to eliminate from the emission spectra the other influences than the structural change of the molecule to which the rare earth complex is bonded. By this, the structural change of the molecule to which the rare earth complex is bonded can be analyzed in further detail by analyzing the spectra whose intensities have been normalized.

Further, the emission spectra are measured in a shorter period of time than the measurement of the CD spectrum conventionally employed for the analysis of the change in the molecular structure.

According to the above method, it is therefore possible to measure the spectra in a short period of time and analyze the minute change in the molecular structure.

According to the structural analysis method of the present invention, it is preferable that the molecule to be structurally analyzed is bonded with plural types of rare earth complexes, in the calculation step, the normalization is performed such that intensities of spectra including the line spectrums due to electric dipole transition from individual types of the rare earth complexes among the measured intensities of the spectra of the light are normalized by intensities at one wavelength in the respective line spectrums due to magnetic dipole transition from the individual types of the rare earth complexes.

According to the calculation step of the above method, it is possible to obtain a plurality of spectra groups in which emission intensities of the spectra including the line spectrums due to the electric dipole transition from the individual types of the rare earth complexes are normalized by the intensities at a specific wavelength in the respective line spectrums due to the magnetic dipole transition from the individual types of the rare earth complexes.

This makes it further possible to analyze the minute change in the molecular structure which minute change occurs simultaneously in the plurality of sites of the molecule.

According to the measurement step of the structural analysis method of the present invention, it is preferable that g values of circularly polarized light of the light emitted from the measurement sample are measured as the intensities of the spectra of the light.

According to the above method, it is further possible to analyze in further detail the minute change in the molecular structure by measuring the g values of the circularly polarized light of the light emitted from the rare earth complex that is bonded to the molecule.

According to the structural analysis method of the present invention, it is preferable that the one wavelength at which the intensity of the line spectrum due to the magnetic dipole transition is attained is a maximum absorbance wavelength of the line spectrum due to the magnetic dipole transition.

According to the above method, it is possible to analyze in further detail the minute change in the molecular structure.

According to the structural analysis method of the present invention, it is preferable that the molecule to be structurally analyzed is a protein.

A structural analysis method of the present invention is characterized in analyzing structural change over time by means of any one of structural analysis methods of the present invention.

According to the above method, the any one of the structural analysis methods of the present invention is employed. It is therefore possible to successively analyze a structure of a molecule with a short interval of time, and it is also possible to analyze the structural change more accurately.

### Advantageous Effects of Invention

As described above, a structural analysis device of the present invention makes it possible to provide a device capable of measuring a spectrum in a short period of time and of analyzing minute change in a molecular structure.

Further, a structural analysis method of the present invention makes it possible to measure the spectrum in a short period of time and to analyze the minute change in the molecular structure.

### BRIEF DESCRIPTION OF DRAWINGS

FIG. 1 is a block diagram schematically showing an arrangement of a structural analysis device in accordance with the present embodiment.

FIG. 2 shows a spectrum obtained by normalizing, by an intensity of a line spectrum at 593 nm, emission spectra of BSA to which a rare earth complex was bonded in Example 1, the emission spectra being measured at various temperatures ranging from 20° C. to 80° C.

FIG. 3 shows a CD spectrum of BSA to which a rare earth complex was bonded in Example 1, the CD spectrum being measured over various temperatures ranging from 20° C. to 80° C.

FIG. 4 shows a spectrum obtained by normalizing, by an intensity of a line spectrum at 593 nm, measured emission spectra of proteins to which a rare earth complex was bonded in Examples 1 and 2.

### DESCRIPTION OF EMBODIMENTS

The following describes in detail the present invention.

What is meant by a term “line spectrum” in the present specification is a spectrum specific to transition between a certain level and another certain level, and what is meant by a term “spectra” in the present specification is whole emitted light or a plurality of line spectrums.

Further, a g value of circularly polarized light is a value calculated by the following formula:

g=(I_{L}−I_{R})/(0.5×(I_{L}+I_{R}))

where I_{R} is an intensity of a right-handed circularly polarized light component of emitted light and I_{L} is an intensity of a left-handed circularly polarized light component of the emitted light.

(I) Structural Analysis Method

A molecule to be analyzed by a structural analysis method of the present embodiment may be any molecules. The structural analysis method of the present embodiment is suitably applicable, particularly to molecules having complicate structures, more specifically to biomolecules such as proteins.

Further, minute change in a molecular structure which minute change can be analyzed by the method of the present embodiment is, for example, (i) a molecular conformational change caused by change in temperature, or (ii) a change in an intermolecular association state.

The structural analysis method of the present embodiment includes an illumination step, a measurement step, a calculation step and a structural analysis step. The following describes these steps in detail.

(a) Illumination Step

The illumination step is a step for illuminating, with excitation light, a molecule to be structurally analyzed to which molecule a rare earth complex is bonded.

As to the rare earth complex that is bonded to the molecule to be structurally analyzed, just one type of rare earth complex may be employed. Alternatively, plural types of rare earth complexes may be employed. In a case where the plural types of rare earth complexes are bonded to the molecule to be structurally analyzed, it is possible to substantially simultaneously analyze minute change that occurs in a plurality of sites of the molecule to be structurally analyzed. Further, it is preferable to select the plural types of rare earth complexes such that emission spectra thereof do not overlap with one another in terms of improving analysis performance.

A method for bonding the rare earth complex to the molecule to be structurally analyzed is not particularly limited. A conventionally well-known method can be employed as the method for bonding the rare earth complex to the molecule to be structurally analyzed. A concrete method for bonding the rare earth complex to the molecule to be structurally analyzed is, for example, a method for bonding in advance, to the molecule to be structurally analyzed, just a ligand of the rare earth complex which ligand is to be bonded to the molecule to be structurally analyzed and then adding a rare earth ion, so that the rare earth complex is bonded to the molecule to be structurally analyzed. The method for bonding the rare earth complex to the molecule to be structurally analyzed is not limited to a covalent bonding method, and may be an ionic bonding method, a hydrogen bonding method or like method.

The rare earth complex is a complex in which a ligand coordinates to a rare earth ion. The rare earth ion employed for the rare earth complex is not limited. It is possible to employ any rare earth element ions.

It is necessary that at least one ligand of the rare earth complex has not only a group that coordinates to the rare earth ion (hereinafter referred to as a “rare earth ion coordination group”) but also a group that is bonded to the molecule to be structurally analyzed (hereinafter referred to as a “target molecule bonding group”) (the at least one ligand is hereinafter referred to as a “target molecule bonding ligand”). The rare earth complex is bonded to the molecule to be structurally analyzed by means of the target molecule bonding ligand.

Examples of the rare earth ion coordination group encompass a bipyridine group, a phenanthroline group, a diketone group, a carbamate group, an amine group, and a phosphine group.

What is meant by the above-described “ . . . group” is a “group having a skeleton of a certain compound or of a derivative of the certain compound”. For example, what is meant by the “bipylidine group” is a “group having a skeleton of bipyridine or a bipyridine derivative”.

Further, the target molecule bonding group is not particularly limited as long as the target molecule bonding group is a group reactive to or associative with a site of the target molecule to which site the rare earth complex is to be bonded. For example, in a case where the rare earth complex is bonded to a lysine part of a protein, it is possible to employ a succinimide group. Further, in a case where the rare earth complex is bonded to a cysteine part of the protein, it is possible to employ an iodomethyl group.

In the target molecule bonding ligand, the rare earth ion coordination group may be directly bonded to the target molecule bonding group, or may be bonded to the target molecule bonding group via a spacer molecule.

In a case where the rare earth ion coordination group is bonded to the target molecule bonding group via the spacer group, it becomes possible to illuminate the rare earth complex with light of a longer wavelength (that is, a longer excitation wavelength). This allows the excitation wavelength to be a wavelength (substantially 450 nm) that is excitable by a blue LED.

The spacer group is preferably a group having an aromatic molecule skeleton and a rigid structure that allows structural change of the target molecule to be easily reflected, such as a biphenylene group (—C₆H₄—C₆H₄—), a terphenylene group (—C₆H₄—C₆H₄—C₆H₄—), a naphthylene group (—C₁₀H₆—), or an anthrylene group (—C₁₄H₁₈—).

A concrete example of the target molecule bonding ligand is a compound having the following structure.

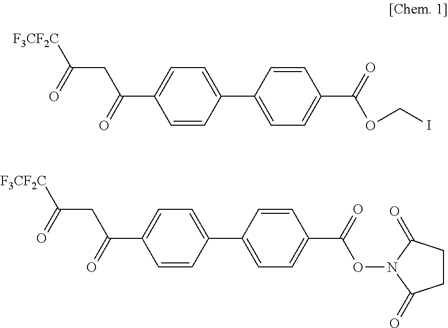

The above-shown compound is merely a typical example, and another derivative can be employed as the target molecule bonding ligand. Further, a compound that belongs to another group or a derivative thereof can also be employed as the target molecule bonding ligand.

Further, a ligand other than the target molecule bonding ligand which ligand coordinates to the rare earth ion is not particularly limited. A conventionally well-known ligand can be employed as the ligand other than the target molecule bonding ligand. Examples of the ligand encompass a bipyridine ligand, a phenanthroline ligand, a diketone ligand, a carbamate ligand, an amine ligand, and a phosphine ligand.

What is meant by the above-described “ . . . ligand” is a “ligand comprising a certain compound or a derivative of the certain compound”. For example, what is meant by the “bipylidine ligand” is a “ligand comprising bipyridine or a bipyridine derivative”.

(b) Measurement Step

The measurement step is a step for receiving light emitted from the rare earth complex and measuring intensities of spectra of the light.

In a case where two or more types of rare earth complexes different in their excitation wavelengths are bonded to the molecule to be structurally analyzed, these rare earth complexes are excited by respective exciting light different in their excitation wavelengths, and then an intensity of a spectrum of light emitted by means of the respective exciting light different in their excitation wavelengths may be measured.

In the measurement step, it is preferable to measure, as the intensity of the spectrum, the intensity of the left-handed circularly polarized light component and the right-handed circularly polarized light component of the light emitted from a measurement sample. That is, it is preferable to measure the g value of the circularly polarized light. This makes it possible to analyze in further detail a structure of the measurement sample.

For example, an unfolded protein has a freely-movable molecular chain that constitutes the protein. It is therefore predictable that the g value of the circularly polarized light of the protein is substantially equal to zero. Meanwhile, a folded protein has a freely-unmovable molecular chain that constitutes the protein. It is therefore predictable that the g value of the circularly polarized light of the protein is not equal to zero. Therefore, it is considered that measuring the g value of the circularly polarized light as the spectrum intensity makes it possible to analyze in further detail a change in a protein structure.

(c) Calculation Step

The calculation step is a step for performing normalization in which emission intensities of spectra including a line spectrum due to electric dipole transition among the measured emission intensities of the spectra are normalized by an intensity at one wavelength in a line spectrum due to magnetic dipole transition.

Specifically, the normalization is attained by dividing all values of the intensities of the spectra including the line spectrum due to the electric dipole transition by a value of the intensity at one wavelength in the line spectrum due to the magnetic dipole transition.

The one wavelength at which the line spectrum due to the magnetic dipole transition is attained is preferably a maximum absorbance wavelength at which the line spectrum due to the magnetic dipole transition can be attained.

Further, all obtained spectra may be normalized, just all line spectrums due to the electric dipole transition may be normalized, or just one or some of the line spectrums due to the electric dipole transition may be normalized.

A molecule to be analyzed can be structurally analyzed not only from the intensity of the line spectrum due to the electric dipole transition but also from a maximum luminescence wavelength or a shape of the line spectrum. It is therefore preferable that at least the all line spectrums due to the electric dipole transition are normalized.

Further, in a case where the plural types of rare earth complexes are bonded to the molecule, the normalization is attained in the calculation step in such a manner that values of the intensities of the spectra including the line spectrums due to the electric dipole transition corresponding to individual types of rare earth complexes among the measured intensities of the spectra are divided by the values of the intensities at one wavelength in the respective line spectrums due to the magnetic dipole transition corresponding to the individual types of rare earth complexes.

(d) Structural Analysis Step

The structural analysis step is a step for analyzing a structure of the molecule to be structurally analyzed from the spectra including the line spectrum due to the electric dipole transition.

The rare earth complex used in the present embodiment is such that the intensity of the line spectrum due to the magnetic dipole transition does not change caused by an environment where a ligand of the rare earth complex of the present embodiment is present, but that the intensity and a shape of the line spectrum due to the magnetic dipole transition change caused by the environment. Specifically, the intensity and the shape of the line spectrum due to the electric dipole transition are affected by change in symmetry of surrounding of a rare earth metal ion. That is, with a less symmetric surrounding of the rare earth metal ion, the intensity of the line spectrum due to the electric dipole transition is increased. Therefore, it is considered that the line spectrum is in a broad shape.

In this manner, structural change of the molecule to be analyzed can be analyzed by observing the intensity, the maximum luminescence wavelength, the shape or the like of the line spectrum due to the electric dipole transition, the intensity of the line spectrum having been normalized by the calculation step.

For example, as described in the following Examples, it is possible to recognize minute change in a structurally analyzed molecular structure caused by change in temperature by observing how the intensity or the shape of the spectrum is changed in association with the change in the temperature.

(II) Structural Analysis Device

The following describes a structural analysis device of the present embodiment employed according to the above-described method, with reference to FIG. 1. FIG. 1 is a block diagram schematically showing an arrangement of the structural analysis device of the present embodiment.

As shown in FIG. 1, a structural analysis device 10 includes: a light source 1 that illuminates, with exciting light, a measurement sample 2 including a molecule to be structurally analyzed to which molecule a rare earth complex is bonded; a measurement section 3 which receives light emitted from the measurement sample 2 and which measures intensities of spectra of the light; a calculation section 4 that performs normalization in which intensities of spectra including a line spectrum due to electric dipole transition among the measured intensities of the spectra are normalized by an intensity at one wavelength in a line spectrum due to magnetic dipole transition; and an output section 7 that outputs the spectra whose intensities have been normalized. The structural analysis device 10 of the present embodiment further includes a measurement chamber 5 for storing the measurement sample 2.

To the measurement sample 2 placed in the measurement chamber 5, the light source 1 emits exciting light having a wavelength corresponding to an absorbance wavelength of the rare earth complex. Examples of the light source 1 encompass light sources capable of emitting light in an ultraviolet region, such as an ultraviolet LED, a black light, a xenon lamp and a short-wavelength semiconductor laser.

The measurement section 3 receives light emitted from the rare earth complex included in the measurement sample 2 and measures spectra intensities of the light (intensity of light). That is, the measurement section 3 receives the light emitted from the rare earth complex that is bonded to the molecule to be structurally analyzed, measures the spectra intensities of the light, and then transmits data of the spectra intensities to the calculation section 4.

The measurement section 3 should measure at least the intensity of the line spectrum due to the electric dipole transition and the intensity of the line spectrum due to the magnetic dipole transition of the received light. The measurement section 3 may also measure spectra intensities of all wavelengths. Alternatively, the measurement section 3 may measure just intensity of light at a predetermined wavelength.

The measurement section 3 is not particularly limited as long as the measurement section 3 can measure light intensity. Examples of the measurement section 3 encompass a photodiode, a photoelectron multiplier, a CCD and a spectrum analyzer. It is more preferable that the measurement section 3 is a device capable of measuring the intensity of the left-handed circularly polarized light component of light, the intensity of the right-handed circularly polarized light component of the light and the g value of the circularly polarized light. An example of such a device is a circularly polarized fluorescence spectrometer such as a JASCO CPL-200 spectrometer manufactured by JASCO Corporation.

By the calculation section 4, the intensities of the spectra including the line spectrum due to the electric dipole transition among the spectrum intensity data transmitted from the calculation section 3 are normalized by the value of the intensity at one wavelength in the line spectrum due to the magnetic dipole transition.

The output section 7 outputs the spectra whose intensities have been normalized by the calculation section 4. An output method is not particularly limited. Examples of the output method encompass displaying the spectra on a display, printing the spectra on a paper and outputting electronic data of the spectra onto a recording medium, and the like method.

As described above, the illumination step, the measurement step and the calculation step of the method of the present embodiment can be carried out by using the structural analysis device 10 of the present embodiment. Subsequently, the structural analysis step of the method of the present embodiment can be carried out by using the spectra outputted from the output section 7 which spectra intensities have been normalized.

Further, a database on what concrete structural change occurs due to change in the intensity, the maximum fluorescence wavelength, the shape or the like of the spectra due to the electric dipole transition is created. This makes it possible to provide a structural analysis section for accessing the database according to the spectra whose intensities have been normalized by the calculation section 4. In this case, data of the spectra whose intensities have been normalized is to be outputted to the structural analysis section.

The above describes a case where the measurement section 3 receives all light emitted from the rare earth complex included in the measurement sample 1. However, the present embodiment is not limited to this case. The present embodiment may be arranged such that a wavelength selection section that transmits just a specific wavelength is additionally provided between the measurement sample 1 and the measurement section 3 and the measurement section 3 receives and measures just light having a wavelength necessary for analysis.

The wavelength selection section is not particularly limited, and a conventionally well-known arrangement of the wavelength selection section may be employed. For example, the wavelength selection section may be arranged such that the emitted light is dispersed by being transmitted through the wavelength selection section, or reflected, diffracted or refracted by the wavelength selection section.

Further, the above describes a case where the measurement section 3 measures all intensities of the spectra of the light emitted from the rare earth complex included in the measurement sample 1. However, the present embodiment is not limited to this case. The measurement section 3 may measure just a part of intensities of the spectra of the light. This makes it possible to shorten a measurement period. For example, in a case where structural change over time is analyzed, it is possible to shorten the interval of the measurement period. This makes it possible to more accurately analyze the structural change.

### EXAMPLES

The following describes the present invention in further detail on the basis of Examples. Note that the present invention is not limited to the following Examples.

(Emission Spectra)

Emission spectra of a measurement sample of the present example were measured by a fluorescence analysis device (HITACHI F-4500). The measurement sample was a solution in which a protein molecule to which a rare earth complex was bonded was dissolved in distilled water. An excitation wavelength of the measurement sample was 365 nm.

[BioT]

A target molecule bonding ligand used in the present Examples was BioT synthesized by KNC Laboratories Co., Ltd.

The BioT was synthesized according to the following synthesis pathway.

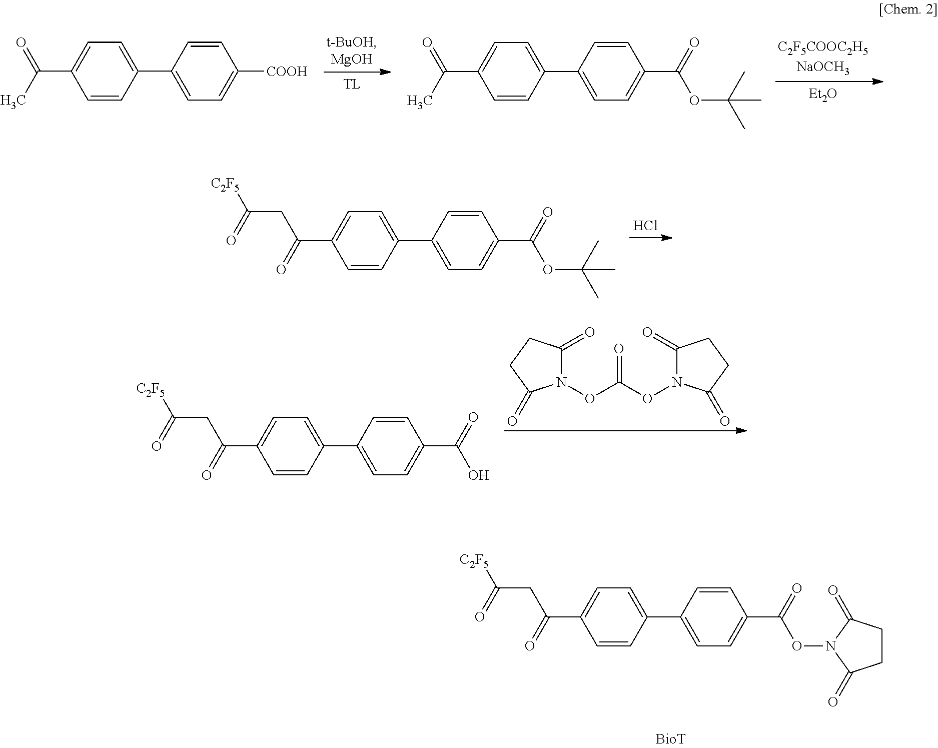

### Example 1

A solution of 5 mg of BSA and 5 mg of BioT in 5 ml of distilled water was stirred at 4° C. for about 16 hours so as to bond the Biot to the BSA. Subsequently, the solution was filtered, and then freeze-dried. It was confirmed by MALDI-TOFMS that four ligands of BioT were bonded to one BSA molecule.

Thereafter, the BSA to which four ligands of BioT have been bonded was reacted with europium chloride hydrate in water at room temperature for 24 hours so as to coordinate Eu (III) to the BSA. As a result of the coordination, the BSA (BSA+BioT+Eu (III)) to which a rare earth complex was bonded was prepared. It was confirmed by electrophoresis that the rare earth complex was bonded to the BSA.

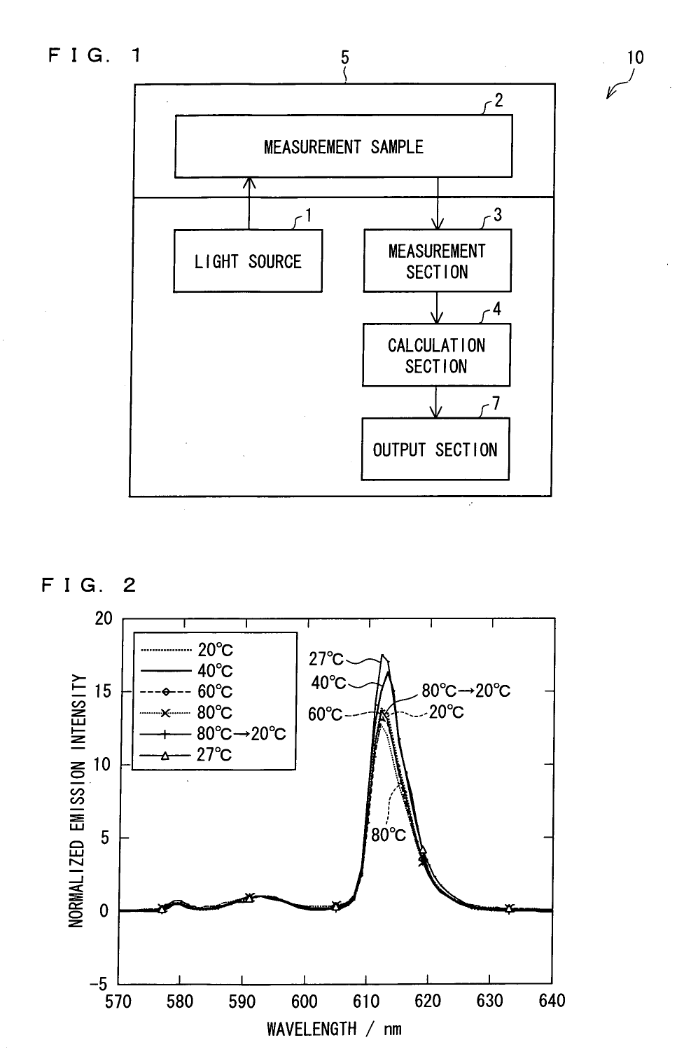

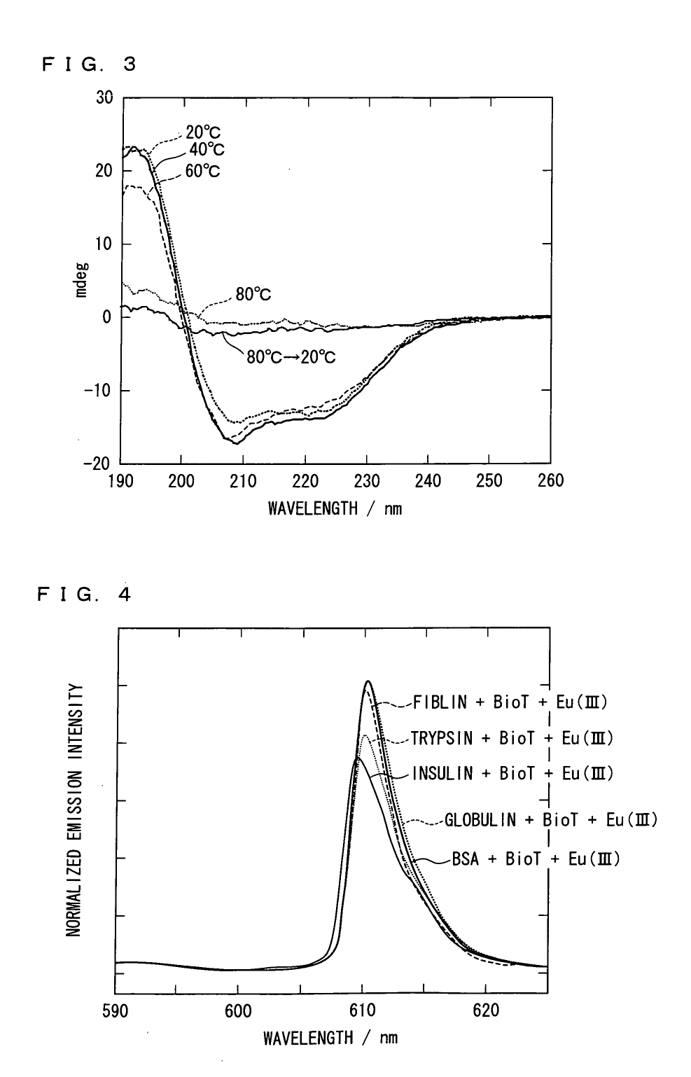

Subsequently, emission spectra of the BSA (BSA+BioT+Eu (III)) to which the rare earth complex was bonded were measured at various temperatures ranging from 20° C. to 80° C. The measured emission spectra were normalized by an intensity of a line spectrum at 593 nm which intensity is one of intensities of line spectrums due to magnetic dipole transition. FIG. 2 shows a spectrum whose intensity was normalized. FIG. 3 shows, as a reference, a result obtained by measuring, at various temperatures ranging from 20° C. to 80° C., a CD spectrum of the BSA (BSA+BioT+Eu (III)) to which the rare earth complex was bonded.

“80° C.→20° C.” shown in FIGS. 2 and 3 indicates a result obtained by measuring a spectrum of the BSA to which the rare earth complex was bonded, the BSA having been heated up to 80° C. and then cooled down to 20° C.

As understood from FIGS. 2 and 3, the CD spectrum shown in FIG. 3 did not show a remarkable change over the temperature change from 20° C. to 40° C., while the normalized spectrum shown in FIG. 2 showed a remarkable change in the intensity of the line spectrum due to the electric dipole transition over the temperature change from 20° C. to 40° C. Further, a maximum absorbance wavelength of the line spectrum due to the electric dipole transition also changed in the normalized spectrum shown in FIG. 2.

As described above, the method of the present invention made it possible to observe minute change in a molecular structure which minute change was difficult to be observed by measurement of the CD spectrum.

### Example 2

A solution of 5 mg of globulin and 5 mg of BioT in 5 ml of distilled water was stirred at 4° C. for about 16 hours so as to bond the Biot to BSA. Subsequently, the solution was filtered, and then freeze-dried. Thereafter, the globulin to which the BioT was bonded was reacted with europium chloride hydrate in water at room temperature for 24 hours so as to coordinate Eu (III) to the globulin. As a result of the coordination, the globulin (globulin+BioT+Eu (III)) to which a rare earth complex was bonded was produced.

Subsequently, emission spectra of the globulin to which the rare earth complex was bonded were measured at room temperature. The measured emission spectra were normalized by an intensity of a line spectrum at 593 nm which intensity is one of intensities of line spectrums due to magnetic dipole transition.

Further, emission spectra of fiblin, trypsin and insulin were also normalized in the same way as the above-described operation, in addition to normalization of the emission spectra of the globulin. FIG. 4 shows the result.

As shown in FIG. 4, intensities and maximum absorbance wavelengths of line spectrums due to electric dipole transition of the normalized emission spectra of these proteins are greatly different from one another. This confirmed that the present invention could distinguish and analyze proteins having different structures.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

A structural analysis method and device of the present invention are capable of analyzing minute change in a dynamic structure of a molecule itself. Therefore, the structural analysis method and device of the present invention are suitably applicable to structural analysis of a biomolecule such as a protein.

### REFERENCE SIGNS LIST

1: light source
2: measurement sample
3: measurement section
4: calculation section
7: output section
10: structural analysis device

1. A structural analysis device, comprising:
a light source for illuminating, with exciting light, a measurement sample including a molecule to be structurally analyzed to which molecule a rare earth complex is bonded;
a measurement section for receiving light emitted from the measurement sample and for measuring intensities of spectra of the light;
a calculation section for performing normalization in which intensities of spectra including a line spectrum due to electric dipole transition among the measured intensities of the spectra of the light are normalized by an intensity at one wavelength in a line spectrum due to magnetic dipole transition; and
an output section for outputting the spectra whose intensities have been normalized.

2. A structural analysis device, comprising:
a light source for illuminating, with exciting light, a measurement sample including a molecule to be structurally analyzed to which molecule a rare earth complex is bonded;
a measurement section for receiving light emitted from the measurement sample plural times and for measuring intensities of spectra of the light each time the light is received;
a calculation section for performing normalization in which intensities of spectra including a line spectrum due to electric dipole transition among the measured intensities of the spectra of the light are normalized by an intensity at one wavelength in a line spectrum due to magnetic dipole transition; and
an output section for outputting the spectra whose intensities have been normalized.

3. The structural analysis device as set forth in claim 1, wherein:
the molecule to be structurally analyzed is bonded with plural types of rare earth complexes,
the calculation section performs normalization in which intensities of spectra including the line spectrums due to electric dipole transition from individual types of the rare earth complexes among the measured intensities of the spectra of the light are normalized by intensities at one wavelength in the respective line spectrums due to magnetic dipole transition from the individual types of the rare earth complexes.

4. The structural analysis device as set forth in claim 1, wherein:
the measurement section measures, as the intensities of the spectra of the light, g values of circularly polarized light of the light emitted from the measurement sample.

5. The structural analysis device as set forth in claim 1, wherein:
the one wavelength at which the intensity of the line spectrum due to the magnetic dipole transition is attained is a maximum absorbance wavelength of the line spectrum due to the magnetic dipole transition.

6. The structural analysis device as set forth in claim 1, wherein:
the molecule to be structurally analyzed is a protein.

7. The structural analysis device as set forth in claim 1, further comprising a structural analysis section, wherein:
the calculation section outputs to the structural analysis section the spectra whose intensities have been normalized,
the structural analysis section structurally analyzes the molecule from the spectra whose intensities have been normalized.

8. A structural analysis method, comprising:
an illumination step for illuminating, with exciting light, a measurement sample including a molecule to be structurally analyzed to which molecule a rare earth complex is bonded;
a measurement step for receiving light emitted from the measurement sample and measuring intensities of spectra of the light;
a calculation step for performing normalization in which intensities of spectra including a line spectrum due to electric dipole transition among the measured intensities of the spectra of the light are normalized by an intensity at one wavelength in a line spectrum due to magnetic dipole transition; and
a structural analysis step for analyzing a structure of the molecule from the spectra whose intensities have been normalized.

9. The structural analysis method as set forth in claim 8, wherein:
the molecule to be structurally analyzed is bonded with plural types of rare earth complexes,
in the calculation step, the normalization is performed such that intensities of spectra including the line spectrums due to electric dipole transition from individual types of the rare earth complexes among the measured intensities of the spectra of the light are normalized by intensities at one wavelength in the respective line spectrums due to magnetic dipole transition from the individual types of the rare earth complexes.

10. The structural analysis method as set forth in claim 8, wherein:
in the measurement step, g values of circularly polarized light of the light emitted from the measurement sample are measured as the intensities of the spectra of the light.

11. The structural analysis method as set forth in claim 8, wherein:
the one wavelength at which the intensity of the line spectrum due to the magnetic dipole transition is attained is a maximum absorbance wavelength of the line spectrum due to the magnetic dipole transition.

12. The structural analysis method as set forth in claim 8, wherein:
the molecule to be structurally analyzed is a protein.

13. A structural analysis method for analyzing structural change of a molecule over time by means of a structural analysis method as set forth in claim 8.

14. The structural analysis device as set forth in claim 2, wherein:
the molecule to be structurally analyzed is bonded with plural types of rare earth complexes,
the calculation section performs normalization in which intensities of spectra including the line spectrums due to electric dipole transition from individual types of the rare earth complexes among the measured intensities of the spectra of the light are normalized by intensities at one wavelength in the respective line spectrums due to magnetic dipole transition from the individual types of the rare earth complexes.

15. The structural analysis device as set forth in claim 2, wherein:
the measurement section measures, as the intensities of the spectra of the light, g values of circularly polarized light of the light emitted from the measurement sample.

16. The structural analysis device as set forth in claim 2, wherein:
the one wavelength at which the intensity of the line spectrum due to the magnetic dipole transition is attained is a maximum absorbance wavelength of the line spectrum due to the magnetic dipole transition.

17. The structural analysis device as set forth in claim 2, wherein:
the molecule to be structurally analyzed is a protein.

18. The structural analysis device as set forth in claim 2, further comprising a structural analysis section, wherein:
the calculation section outputs to the structural analysis section the spectra whose intensities have been normalized,
the structural analysis section structurally analyzes the molecule from the spectra whose intensities have been normalized.
